(19) United States
(12) Patent Application Publication
(10) Pub. No.: US 2024/0248296 A1
(43) Pub. Date: Jul. 25, 2024

(54) OPTICAL SYSTEM AND DISPLAY APPARATUS

(71) Applicant: CANON KABUSHIKI KAISHA, Tokyo (JP)

(72) Inventors: Yu MIYAJIMA, Tochigi (JP); Keigo YARITA, Tokyo (JP); Yuma KOBAYASHI, Tochigi (JP); Kazuto ISHIDA, Tochigi (JP)

(21) Appl. No.: 18/399,806

(22) Filed: Dec. 29, 2023

(30) Foreign Application Priority Data
Jan. 24, 2023 (JP) 2023-008475

(51) Int. Cl. G02B 25/00

(52) U.S. Cl. CPC G02B 25/001

(57) ABSTRACT

An optical system through which light from a display surface is guided to a pupil surface includes, in order from a pupil surface side to a display surface side, a first optical system, a first transmissive reflective member having a first transmissive reflective surface that is a curved surface, a second optical system, a second transmissive reflective member having a second transmissive reflective surface that is a curved surface, and a third optical system. A lens closest to the display surface in the first optical system and a lens disposed closest to the pupil surface in the second optical system are cemented with each other via the first transmissive reflective member. A lens closest to the display surface in the second optical system and a lens disposed closest to the pupil surface in the third optical system are cemented with each other via the second transmissive reflective member.

### BACKGROUND

### Technical Field

One of the aspects of the embodiments relates to an optical system and a display apparatus.

### Description of Related Art

A display apparatus (observation apparatus) such as a head mount display (HMD) has recently been known that provides realistic experience by enlarging an original image displayed with a display element, such as a liquid crystal display (LCD), through an observation optical system and by providing a large screen image to a user. Since the display apparatus is mounted on the user's head when used, the observation optical system included in the display apparatus is demanded to have a wide field and high optical performance as well as have a small size (low profile). Japanese Patent No. 6984261 discloses an optical system that reduces chromatic aberration by using a cemented lens.

In the optical system disclosed in Japanese Patent No. 6984261, one transmissive reflective surface is a flat surface, and thus it is difficult to improve imaging performance or achieve high definition.

### SUMMARY

An optical system according to one aspect of the embodiment through which a light beam from a display surface is guided to a pupil surface includes, in order from a pupil surface side to a display surface side, a first optical system having at least one lens, a first transmissive reflective member having a first transmissive reflective surface that is a curved surface, a second optical system having at least one lens, a second transmissive reflective member having a second transmissive reflective surface that is a curved surface, and a third optical system having at least one lens. A lens disposed closest to the display surface in the first optical system and a lens disposed closest to the pupil surface in the second optical system are cemented with each other via the first transmissive reflective member. A lens disposed closest to the display surface in the second optical system and a lens disposed closest to the pupil surface in the third optical system are cemented with each other via the second transmissive reflective member. A display apparatus having the above optical system constitutes another aspect of the embodiment.

Further features of the disclosure will become apparent from the following description of embodiments with reference to the attached drawings.

### BRIEF DESCRIPTION OF THE DRAWINGS

FIGS. 1A and 1B are a sectional view and an aberration diagram of an optical system according to Example 1.

FIG. 2 schematically illustrates an optical path of the optical system according to Example 1.

FIGS. 3A, 3B, and 3C explain a first transmissive reflective surface and a second transmissive reflective surface.

FIGS. 4A and 4B are a sectional view and an aberration diagram of the optical system according to Example 1.

FIGS. 5A and 5B are a sectional view and an aberration diagram of the optical system according to Example 1.

FIGS. 6A and 6B are a sectional view and an aberration diagram of an optical system according to Example 2.

### DESCRIPTION OF THE EMBODIMENTS

Referring now to the accompanying drawings, a detailed description will be given of embodiments according to the disclosure.

An optical system according to each example is an optical system (bending optical system) through which a light beam from a display surface of a display element (panel portion) is guided to an observation surface (pupil surface), and is an observation optical system for observing an image displayed on the display surface. The optical system according to each example and the display element constitute an display apparatus. The optical system according to each example includes, in order from the pupil surface side to the display surface side, a first optical system (pupil-surface-side optical system), a first transmissive reflective member, a second optical system (transmissive reflective optical system), a second transmissive reflective member, and a third optical system (panel-side optical system).

The first transmissive reflective member has a first transmissive reflective surface that is a curved surface. The second transmissive reflective member has a second transmissive reflective surface that is a curved surface. A lens disposed closest to the display surface in the first optical system and a lens disposed closest to the pupil surface in the second optical system are cemented with each other via the first transmissive reflective member. A lens disposed closest to the display surface in the second optical system and a lens disposed closest to the pupil surface in the third optical system are cemented with each other via the second transmissive reflective member.

The first optical system is an optical system sandwiched between the pupil surface and the second optical system. The second optical system is an optical system sandwiched between two transmissive reflective surfaces (the first transmissive reflective surface and the second transmissive reflective surface) serving as a transmissive surface and a reflective surface. The third optical system is an optical system sandwiched between the second optical system and the display element. The first optical system and the third optical system may not be provided. Hereinafter, each example will be described in detail.

### Example 1

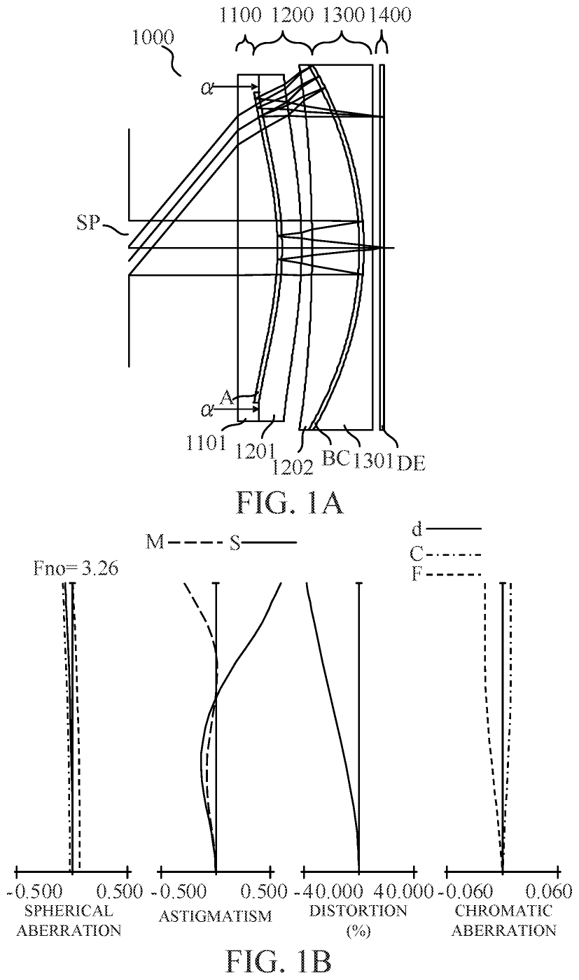

A description will now be given of an optical system (observation optical system) 1000 according to Example 1. FIG. 1A is a sectional view of the optical system 1000. The optical system 1000 includes a pupil-surface-side optical system (first optical system) 1100, a first transmissive reflective member (A), a transmissive reflective optical system (second optical system) 1200, a second transmissive reflective member (C), and a panel-side optical system (third optical system) 1300.

The pupil-surface-side optical system 1100 includes an optical element (first lens) 1101, the transmissive reflective optical system 1200 includes an optical element (second lens) 1201 and an optical element (third lens) 1202, and the panel-side optical system 1300 includes an optical element (fourth lens) 1301. Thus, in this example, the number of optical elements (optical elements 1101, 1201, 1202, and 1301) that each refracts, reflects, or diffracts a light beam is one for the pupil-surface-side optical system 1100, two for the transmissive reflective optical system 1200, and one for the panel-side optical system 1300.

Each optical element has two optical surfaces, which will be referred to as an R1 surface and an R2 surface in order from the pupil surface side. The R1 surface of the optical element 1101 is a flat surface, and the R2 surface of the optical element 1101 is a curved surface. The R1 and R2 surfaces of each of the optical elements 1201 and 1202 are curved surfaces. The R1 surface of the optical element 1301 is a curved surface, and the R2 surface of the optical element 1301 is a flat surface. The optical elements 1101, 1202, and 1301 is made of PMMA (acrylic resin). However, this example is not limited to this material and acrylic resin may be applied to each optical element instead of using acrylic resin as the material of the optical element.

A ray from a panel portion (display element) 1400 passes through the panel-side optical system 1300 and the transmissive reflective optical system 1200, is reflected by the first transmissive reflective surface, is reflected by the second transmissive reflective surface, passes through the transmissive reflective optical system 1200 and the pupil-surface-side optical system 1100, and travels toward a pupil surface SP. Thereby, through the optical system 1000, an optical image on the panel portion 1400 can be observed from the pupil surface SP at which an exit pupil of the optical system 1000 is positioned. Light tracing an optical path in this case will be referred to as desired light, and other light will be referred to as unnecessary light.

FIG. 1B is an aberration diagram of the optical system 1000 in a case where an eye relief (distance from the pupil surface SP to a pupil-facing surface of the pupil-surface-side optical system 1100 (lens surface disposed closest to the pupil surface in the pupil-surface-side optical system 1100)) is 12 mm and a virtual image is displayed at a position of 1600 mm from the pupil surface SP. FIG. 1B illustrates aberrations at the wavelengths of the d-line (587.6 nm), the F-line (486.1 nm), and the C-line (656.3 nm), which are design reference wavelengths. It is understood from FIG. 1B that satisfactory imaging performance can be obtained. FIG. 1B illustrates aberrations with an image plane at the panel portion 1400 along a backward optical path (reverse trace) from the pupil surface SP to the panel portion 1400 instead of the forward optical path (forward trace) from the panel portion 1400 to the pupil surface SP. This causes no problem because the aberrations correspond to aberrations for the forward optical path (forward trace) in a case where optical performance of the optical system 1000 is considered. In the following description, a thickness of 0.5 mm, a refractive index of 1.52, and an Abbe number of 64 are examples of approximate properties of elements such as a polarization plate, a quarter waveplate, and a polarization selective transmissive reflective element, and thus the properties may have different values in reality.

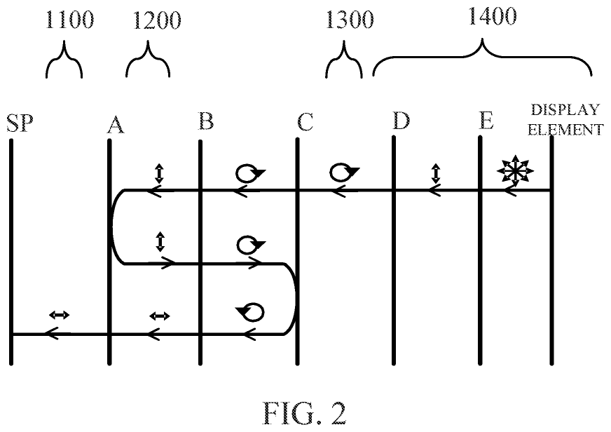

Referring now to FIG. 2, a description will be given of the optical path of the optical system 1000. FIG. 2 schematically illustrates the optical path of the optical system 1000, and illustrates the direction of the optical path passing through each surface and a polarization state above the direction. The description will be made on the optical path of the desired light but not on the optical path of the unnecessary light attributable to each element of the optical system 1000.

The optical system 1000 includes, in order from the pupil surface SP, the pupil-surface-side optical system 11000, a polarization selective transmissive reflective element A, the transmissive reflective optical system 1200, a first quarter waveplate B, a transmissive reflective surface (half-mirror) C, the panel-side optical system 1300, and the panel portion 1400. The polarization selective transmissive reflective element A corresponds to the first transmissive reflective member having the first transmissive reflective surface, and the transmissive reflective surface C corresponds to the second transmissive reflective member having the second transmissive reflective surface. The panel portion 1400 includes a display element (light modulator) such as a liquid crystal display element or an organic EL element, a polarization plate E, and a second quarter waveplate D. The shape of the display element is a square with a diagonal 1.6 inch (28.7 mm on each side). The polarization plate E and the second quarter waveplate D are disposed in proximity in this order from the display element to the pupil surface side.

A nonpolarized ray emitted from the display element becomes linearly polarized light through the polarization plate E, is converted into circularly polarized light through the second quarter waveplate D, passes through the panel-side optical system 1300, and travels toward the transmissive reflective optical system 1200. The polarization plate E may be integrated with an image display element. For example, a liquid crystal display element often includes a polarization plate in its configuration. Furthermore, an organic EL element sometimes includes a polarization plate for antireflection, and in this case, an emission light (exit light) from the image display element is linearly polarized light. In such cases, the polarization plate E does not need to be additionally provided.

The polarization selective transmissive reflective element A and the transmissive reflective surface (half-mirror) C are two transmissive reflective surfaces (the first transmissive reflective surface and the second transmissive reflective surface) serving as a transmissive surface and a reflective surface. The transmissive reflective surface (half-mirror) C is formed of a dielectric multilayer film or a metal film and functions as a transmissive reflective surface (the second transmissive reflective surface).

The first quarter waveplate B is disposed in a state in which the slow axis of the first quarter waveplate B is tilted by 90° relative to the slow axis of the second quarter waveplate D and tilted by 45° relative to the polarization transmissive axis of the polarization plate E. The R1 surface of the optical element 1301 is evaporated with the transmissive reflective surface (half-mirror) C. The first quarter waveplate B is bonded to the R2 surface of the optical element 1202 and the R1 surface of the optical element 1301 evaporated with the transmissive reflective surface (half-mirror) C.

The polarization selective transmissive reflective element A is an element configured to reflect linearly polarized light having the same polarization direction as that passing through the polarization plate E and transmit linearly polarized light having a polarization direction orthogonal to this. In other words, the polarization selective transmissive reflective element A is a reflective polarizer that separates incident light into reflected light and transmitting light in accordance with its polarization state, and is, for example, a wire grid polarizer or a stacked birefringent film polarizer. More specifically, the wire grid polarizer is, for example, “WGF” manufactured by Asahi Kasei Corporation and its wire grid formation surface functions as a transmissive reflective surface. In this example, the polarization selective transmissive reflective element A is bonded to the R2 surface of the optical element 1101 included in the pupil-surface-side optical system 1100 and the R1 surface of the optical element 1201 included in the transmissive reflective optical system 1200.

Each transmissive reflective member is a member having a transmissive reflective surface, connected to the transmissive reflective surface, having substantially no refractive power, and mainly exerting an optical function (such as absorption in accordance with the polarization state, change of the polarization state, or antireflection) other than refraction or a mechanical function (such as bonding or protection). In this example, the polarization selective transmissive reflective element A is the first transmissive reflective member, and the transmissive reflective surface (half-mirror) C is the second transmissive reflective member. Each transmissive reflective member may be a connected member having a plurality of functions. The thickness of each transmissive reflective member is normally equal to or smaller than 0.5 mm or is equal to or smaller than 1 mm at most.

The desired light in light incident on the transmissive reflective surface (half-mirror) C transmits through the transmissive reflective surface (half-mirror) C, is converted through the first quarter waveplate B into linearly polarized light having the same polarization direction as that passing through the polarization plate E, and enters the polarization selective transmissive reflective element A. This linearly polarized light is reflected in accordance with polarization selectivity of the polarization selective transmissive reflective element A. The light reflected by the polarization selective transmissive reflective element A is converted through the first quarter waveplate B into the same circularly polarized light as that having been converted into circularly polarized light through the second quarter waveplate D for the first time, enters the transmissive reflective surface (half-mirror) C, and is reflected by the transmissive reflective surface (half-mirror) C. The light reflected by the transmissive reflective surface (half-mirror) C becomes circularly polarized light having a polarization direction opposite to that of the pre-reflection light, enters the first quarter waveplate B again, is converted into linearly polarized light having a polarization direction orthogonal to the polarization direction of the linearly polarized light passing through the polarization plate E for the first time, and enters the polarization selective transmissive reflective element A. This linearly polarized light transmits through the polarization selective transmissive reflective element A in accordance with its polarization selective and is guided to the pupil surface SP.

A bending optical system typically reduces curvature of field by canceling influence of the reflective power of two transmissive reflective surfaces and influence of the refractive power of all refractive surfaces at the viewpoint of the Petzval sum, thereby achieving satisfactory imaging performance (in other words, providing high-definition images). Thus, if one of the transmissive reflective surfaces is a flat surface as disclosed in Japanese Patent No. 6984261, the reflective power freedom is reduced to one, the optical design freedom for reducing curvature of field is significantly impaired, and it becomes difficult to provide high imaging performance.

More specifically, the refractive power of a refractive surface necessary for the bending optical system can be made small in the configuration in which influence of the reflective powers of two transmissive reflective surfaces is mutually canceled out from the viewpoint of the Petzval sum. Thus, a lens (refractive or dioptric optical element) having strong refractive power does not need to be provided unlike Japanese Patent No. 6984261, and excellent imaging performance can be obtained.

On the other hand, in the configuration in which influence of the reflective powers of two transmissive reflective surfaces are not mutually canceled out from the viewpoint of the Petzval sum, a lens (refractive optical element) having strong refractive power needs to be provided to a bending optical system like Japanese Patent No. 6984261. However, the reflective power necessary for the bending optical system distributed to two transmissive reflective surfaces is suitable from the viewpoint of imaging performance because the reflective power of each transmissive reflective surface can be decreased, in comparison with a case where one of the transmissive reflective surfaces is a flat surface. In this example, the two transmissive reflective surfaces are both curved surfaces. Thereby, excellent imaging performance (in other words, image definition increase) can be achieved.

Reflection of a transmissive reflective surface has been described above, and refraction thereof will be described next. In a case where the transmissive reflective surface contacts air, large refractive power is generated at the transmissive reflective surface. Then, in the optical design, the shape of the transmissive reflective surface is optimized to a balanced shape with consideration on influence of both reflective power and refractive power. Although both powers may be compromised, only reflective power may be easily controlled from the viewpoint of the optical design freedom.

In this example, the optical element 1101 and the optical element 1201 as refractive optical elements are cemented with each other via the first transmissive reflective member having the first transmissive reflective surface, and the optical element 1202 and the optical element 1301 as refraction optical elements are cemented with each other via the second transmissive reflective member having the second transmissive reflective surface. This configuration in which each transmissive reflective member having a transmissive reflective surface is sandwiched between refractive optical elements can make the refractive power of the transmissive reflective surface smaller than that of a configuration in which the transmissive reflective surface contacts air. As a result, in determining the shape of the transmissive reflective surface, only influence of reflective power needs to be mainly considered, and this configuration can improve the optical design freedom and improve imaging performance. Cementing is not limited to bonding using an adhesive agent but includes evaporation and crimping. Moreover, cementing means cementing at least in part of an effective area through which light passes, and does not necessarily include cementing in the entire effective area nor out of the effective area. This example can provide effects of securing the optical design freedom and providing high-definition images.

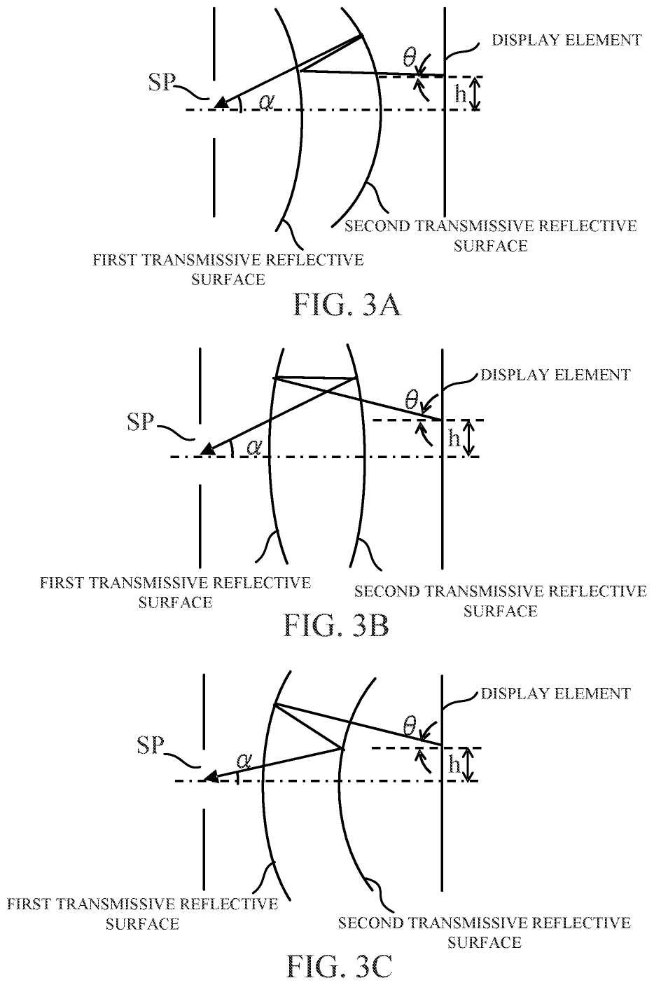

FIGS. 3A, 3B, and 3C schematically illuminate the optical path of a ray emitted from an image height h on the display element, an emission angle θ of the display element, and an angle of view α on the pupil surface SP in accordance with the concave-convex shapes of two transmissive reflective surfaces. Influence of refraction is omitted because influence of reflection will be described. Furthermore, it is clear that the Petzval sum is not excellent if the first transmissive reflective surface is concave on the pupil surface side and the second transmissive reflective surface is convex on the pupil surface side, and thus a description thereof will be omitted. For simplification, the description will be made for a substantially spherical shape, not for a complicate aspherical surface shape. The display element normally performs Lambert light emission, and thus a capturing light amount is larger (in other words, high light quantity) as the emission angle θ is smaller. Moreover, a sense of immersion is obtained as the angle of view α is larger (in other words, wide field angle).

FIG. 3A illustrates a case where the first transmissive reflective surface and the second transmissive reflective surface both have a shape that is concave on the pupil surface side. This configuration is suitable to decrease the emission angle θ and to increase the angle of view α. FIG. 3B illustrates a case where the first transmissive reflective surface has a shape that is convex on the pupil surface side and the second transmissive reflective surface has a shape that is concave on the pupil surface side. This configuration is suitable to increase the angle of view α but is not suitable to decrease the emission angle θ. FIG. 3C illustrates a case where the first transmissive reflective surface and the second transmissive reflective surface both have a shape that is convex on the pupil surface side. This configuration is not suitable to decrease the emission angle θ or increase the angle of view α. That is, when only influence of reflection is considered, the first transmissive reflective surface and the second transmissive reflective surface may both have a shape that is concave on the pupil surface side as in this example (FIG. 3A) from the viewpoint of the emission angle θ and the angle of view α. In other words, this configuration can easily reconcile both high light amount and a wide field angle.

In this example, the optical element 1201 sandwiching the first transmissive reflective surface and the optical element 1202 sandwiching the second transmissive reflective surface are spaced or separated from each other via a void space. Due to this configuration, refraction occurs at each of the R2 surface of the optical element 1201 and the R1 surface of the optical element 1202, and imaging performance is improved. The R2 surface of the optical element 1201 and the R1 surface of the optical element 1202 do not necessarily need to be curved surfaces nor have refractive power. Even in a case where the transmissive reflective surface is a flat surface, imaging performance can be improved by properly setting its position in the optical axis direction in the optical design freedom to properly set the positions and angles of light incident on the first transmissive reflective surface and the second transmissive reflective surface.

This example provides an unillustrated diopter adjustment mechanism that defocuses an integrated element in which the optical elements 1202 and 1301 sandwiching the second transmissive reflective surface is integrated, and can perform focusing in accordance with the vision of a viewer (diopter adjustment or parallax adjustment).

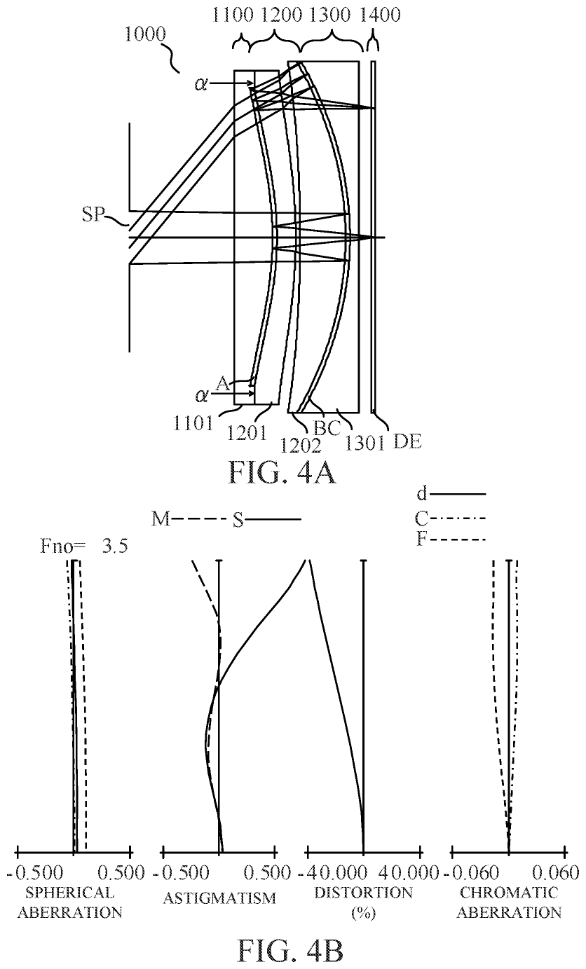

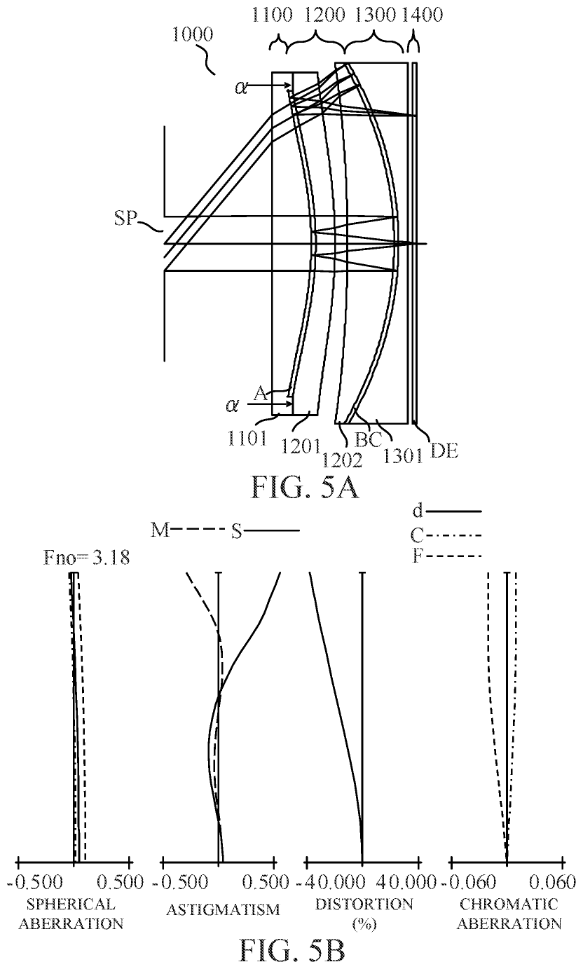

FIG. 4A illustrates an optical path diagram of the optical system 1000 in a case (negative diopter adjustment) where diopter adjustment is performed for a person having vision of −5D (short-sightedness), and FIG. 4B illustrates an aberration diagram in the case. FIG. 5A illustrates an optical path diagram of the optical system 1000 in a case (positive diopter adjustment) where diopter adjustment is performed for a person having vision of +2D (long-sightedness), and FIG. 5B illustrates an aberration diagram in the case. It can be understood that sufficiently excellent imaging performance is obtained despite of diopter adjustment.

Table 1 summarizes distances between the optical elements together with surface numbers for cases of no diopter adjustment, negative diopter adjustment, and positive diopter adjustment in the optical system 1000.

TABLE 1

| | NO DIOPTER | NEGATIVE DIOPTER | POSITIVE DIOPTER |
|---|---|---|---|
| | ADJUSTMENT | ADJUSTMENT | ADJUSTMENT |
| d1 | 12 | 12 | 12 |
| d5 | 1.15 | 0.504 | 1.377 |
| d10 | −1.15 | −0.504 | −1.377 |
| d15 | 1.15 | 0.504 | 1.377 |
| d19 | 0.75 | 1.396 | 0.523 |

Thus, diopter adjustment can be performed by adjusting a distance between the first transmissive reflective surface and the second transmissive reflective surface (by changing the distance during parallax adjustment).

Table 2 summarizes a radius of curvature r and a curvature Φ (the reciprocal of the radius of curvature r) of each of the R1 surface of the optical element 1101, the first transmissive reflective surface, the R2 surface of the optical element 1201, the R1 surface of the optical element 1202, the second transmissive reflective surface, the R2 surface of the optical element 1301.

TABLE 2

| | RADIUS OF | |
|---|---|---|
| | CURVATURE r | CURVATURE Φ |
| R1 SURFACE OF | ∞ | 0 |
| OPTICAL ELEMENT 1101 | | |
| FIRST TRANSMISSIVE | −36.6 | −0.02732 |
| REFLECTIVE SURFACE | | |
| R2 SURFACE OF | −60 | −0.01667 |
| OPTICAL ELEMENT 1201 | | |
| R1 SURFACE OF | −165 | −0.00606 |
| OPTICAL ELEMENT 1202 | | |
| SECOND TRANSMISSIVE | −37 | −0.02703 |
| REFLECTIVE SURFACE | | |
| R2 SURFACE OF | | 0 |
| OPTICAL ELEMENT 1301 | | |

As shown in Table 2, at least one surface of each refractive optical element adjacent to the first transmissive reflective surface or the second transmissive reflective surface has an opposite sign to that of the curvature of the first transmissive reflective surface or the second transmissive reflective surface or is close to a flat surface (with a curvature of a small absolute value). The signs of the radius of curvature and the curvature are those for an optical system from the pupil surface SP toward the display element. Since the two transmissive reflective surfaces are determined based mainly on influence of reflective power as described above, refractive power needed as a property of the bending optical system may be often decreased. As a result, the refractive surface of the refractive optical element adjacent to the transmissive reflective surface can be set to have a shape with the opposite sign to that of the transmissive reflective surface or close to a flat surface (with a curvature of a small absolute value) and can be easily manufactured.

This example may satisfy at least one of the following inequalities (1):

$$Φ 1 a \times Φ 1 b \leq 0 and \vert Φ 1 a \vert > \vert Φ 1 b \vert \qquad ( 1 )$$

where Φ1a is the curvature (1/mm) of the first transmissive reflective surface, and Φ1b (1/mm) is the curvature of a lens surface of at least one of a lens disposed closest to the display surface in the pupil-surface-side optical system 1100 and a lens disposed closest to the pupil surface in the transmissive reflective optical system 1200.

This example may satisfy at least one of the following inequalities (2):

$$Φ 2 a \times Φ 2 b \leq 0 and \vert Φ 2 a \vert > \vert Φ 2 b \vert \qquad ( 2 )$$

where Φ2a is a curvature (1/mm) of the second transmissive reflective surface, and Φ2b (1/mm) is a curvature of a lens surface of at least one of a lens disposed closest to the display surface in the transmissive reflective optical system 1200 and a lens disposed closest to the pupil surface in the panel-side optical system 1300.

In this example, ν1b=22.4, ν2a=57.4, and |ν1b−ν2a|=35, where ν1b is an Abbe number of the optical element 1201 based on the d-line and ν2a is an Abbe number of the optical element 1202 based on the d-line. Since the desired light passes between the two transmissive reflective surfaces three times, the Abbe number difference is effective even if it is small, and chromatic aberration can be effectively reduced by using glass materials having an Abbe number difference of 7 or more.

In this example, the following inequality (3) may be satisfied:

$$7 \leq \vert ν 1 b - ν 2 a \vert \qquad ( 3 )$$

Inequality (3) may be replaced with inequality (3a) below:

$$10 \leq \vert ν 1 b - ν 2 a \vert \qquad ( 3 a )$$

Inequality (3) may be replaced with inequality (3b) below:

$$15 \leq \vert ν 1 b - ν 2 a \vert \qquad ( 3 b )$$

In this example, ν1a=57.4 and |ν1a−ν1b|=35, where ν1a is an Abbe number of the optical element 1101 based on the d-line.

In this example, the following inequality (4) may be satisfied:

$$20 \leq \vert ν 1 a - ν 1 b \vert \qquad ( 4 )$$

Inequality (4) may be replaced with inequality (4a) below:

$$25 \leq \vert ν 1 a - ν 1 b \vert \qquad ( 4 a )$$

Inequality (4) may be replaced with inequality (4b) below:

$$30 \leq \vert ν 1 a - ν 1 b \vert \qquad ( 4 b )$$

In this example, the following inequality (5) may be satisfied:

$$20 \leq \vert ν 2 a - ν2 b \vert \qquad ( 5 )$$

where ν2b is an Abbe number of the optical element 1301 based on the d-line:

Inequality (5) may be replaced with inequality (5a) below:

$$25 \leq \vert v 2 a - v 2 b \vert \qquad ( 5 a )$$

Inequality (5) may be replaced with inequality (5b) below:

$$30 \leq \vert v 2 a - v 2 b \vert \qquad ( 5 b )$$

Thus, chromatic aberration can be reduced by using glass materials having an Abbe number difference of 20 or more between two refractive optical elements sandwiching each transmissive reflective surface although it is less effective than in a case where a refractive optical element of a different glass material is provided between two transmissive reflective surfaces. Alternatively, even this example can obtain the same effect by using different glass materials as the two refraction optical elements sandwiching the second transmissive reflective surface.

In this example, n1a=1.49171, n1b=1.6422, and |n1a−n1b|=0.15049, where n1a is a refractive index of the optical element 1101 and n1b is a refractive index of the optical element 1201.

In this example, the following inequality (6) may be satisfied:

$$\vert n 1 a - n 1 b \vert \leq 0.2 \qquad ( 6 )$$

Inequality (6) may be replaced with inequality (6a) below:

$$\vert n 1 a - n 1 b \vert \leq 0.15 \qquad ( 6 a )$$

Inequality (6) may be replaced with inequality (6b) below:

$$\vert n 1 a - n 1 b \vert \leq 0.1 \qquad ( 6 b )$$

Similarly, n2a=1.49171, n2b=1.49171, and |n2a−n2b|=0, where n2a is a refractive index of the optical element 1202 and n2b is a refractive index of the optical element 1301.

In this example, the following inequality (7) may be satisfied:

$$\vert n 2 a - n 2 b \vert \leq 0.2 \qquad ( 7 )$$

Inequality (7) may be replaced with inequality (7a) below:

$$\vert n 2 a - n 2 b \vert \leq 0.15 \qquad ( 7 a )$$

Inequality (7) may be replaced with inequality (7b) below:

$$\vert n 2 a - n 2 b \vert \leq 0.1 \qquad ( 7 b )$$

Thus, the refractive power of the transmissive reflective surface can be decreased by reducing the refractive index difference between refraction optical elements sandwiching the transmissive reflective surface, and can improve the optical design freedom and imaging performance as described above.

In this example, the two refraction optical elements sandwiching the second transmissive reflective surface are both made of PMMA (acrylic resin). Since the two refraction optical elements are made of the same material, expansion at temperature change, moisture absorption, or the like can be the same between them and variation at environment change can be reduced. This example can obtain the same effect even in a case where the two refraction optical elements sandwiching the first transmissive reflective surface are made of the same material.

In this example, the side surface of the first transmissive reflective member, which includes the polarization selective transmissive reflective element A, in a direction orthogonal to the optical axis is sealed by cementing (a in FIGS. 1A, 4A, and 5A) of the outer shapes of the optical elements 1101 and 1201 and does not contact air. This configuration in which the transmissive reflective surface does not directly contact air can prevent performance degradation and endurance degradation due to moisture absorption.

In this example, the diameter of the first transmissive reflective member is smaller than the diameters of the optical elements 1101 and 1201 in the above configuration, but this is not essential. For example, the diameter of the transmissive reflective member and the diameter of a refraction optical element cemented thereto may be equivalent and the side surface of the transmissive reflective member in the direction orthogonal to the optical axis may be provided with a protective film or covered with another member.

While refractive power depends on the refractive index of a glass material, the refractive power of each transmissive reflective surface is reduced as described above in the configuration according to this example. As a result, the optical design freedom in glass material selection improves in comparison with a case where the transmissive reflective surface contacts air and has large refractive power. With the improved freedom, PMMA (acrylic resin), which has hardness and chemical resistance higher than those of normal resin, is used as the material of the optical element 1101 serving as the pupil-facing surface facing the pupil surface SP. Typically, the antifouling standard is strict for the pupil-facing surface that a viewer potentially touches. Thereby, even in a case where the antifouling standard is stricter than normal, no hard coating nor antifouling glass needs to be provided, and thus a cost reduction effect can be obtained.

### Example 2

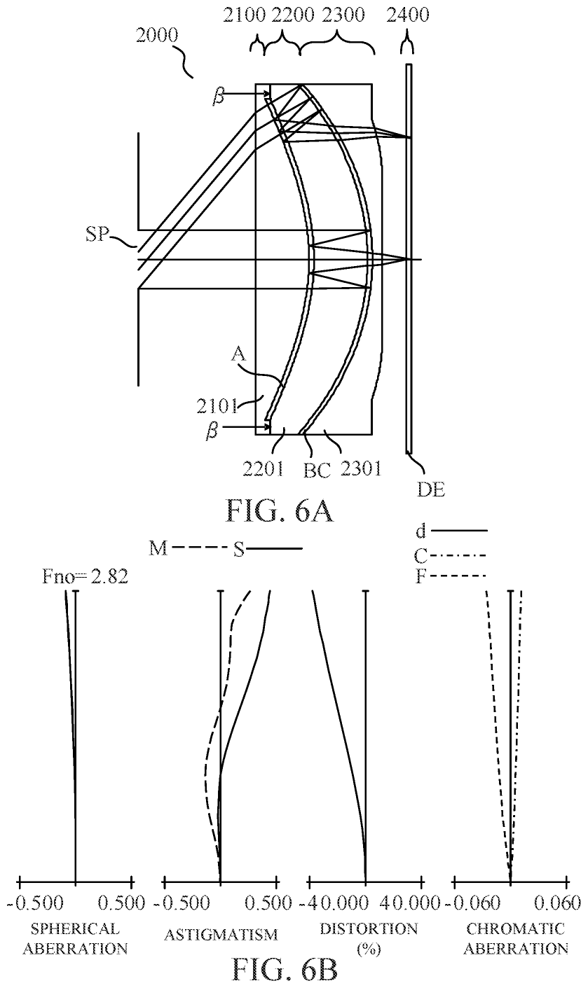

A description will now be given of an optical system (observation optical system) 2000 according to Example 2. In this example, a description common to that of Example 1 will be omitted. FIG. 6A is a sectional view of the optical system 2000. The optical system 2000 includes a pupil-surface-side optical system (first optical system) 2100, the first transmissive reflective member (A), a transmissive reflective optical system (second optical system) 2200, the second transmissive reflective member (C), and a panel-side optical system (third optical system) 2300.

The pupil-surface-side optical system 2100 includes an optical element (first lens) 2101, the transmissive reflective optical system 2200 includes an optical element (second lens) 2201, and the panel-side optical system 2300 includes an optical element (third lens) 2301. Thus, the number of optical elements (optical elements 2101, 2201, and 2301) that each refracts, reflects, or diffracts a light beam is one for each of the pupil-surface-side optical system 2100, the transmissive reflective optical system 2200, and the panel-side optical system 2300 in this example. The R1 surface of the optical element 2101 is a flat surface, and the R2 surface of the optical element 2101 is a curved surface. The R1 and R2 surfaces of each of the optical elements 2201 and 2301 are both curved surfaces. The optical elements 2101 and 2201 is made of PMMA (acrylic resin).

A ray from a panel portion (display element) 2400 passes through the panel-side optical system 2300 and the transmissive reflective optical system 2200, is reflected once at each of the first transmissive reflective surface and the second transmissive reflective surface, passes through the transmissive reflective optical system 2200 and the pupil-surface-side optical system 2100, and travels toward the pupil surface SP. Thereby, through the optical system 2000 according to this example, an optical image on the panel portion 2400 can be observed from the pupil surface SP at which the exit pupil thereof is positioned. Light tracing the optical path in this case will be referred to as desired light, and other light will be referred to as unnecessary light.

FIG. 6B is an aberration diagram of the optical system 2000 in a case where an eye relief (distance from the pupil surface SP to the pupil-facing surface of the pupil-surface-side optical system 2100 (lens surface disposed closest to the pupil surface in the pupil-surface-side optical system 2100)) is 12 mm and a virtual image is displayed at the position of 1600 mm from the pupil surface SP. It is understood from FIG. 6B that excellent imaging performance is obtained.

The configuration of the panel portion 2400 is equivalent to that of the panel portion 1400 according to Example 1. However, the shape of the panel portion 2400 is a square (25.2 mm on each side) with a diagonal of 1.4 inch. The R1 surface of the optical element 2301 is evaporated with the transmissive reflective surface (half-mirror) C. The first quarter waveplate B is bonded to the R2 surface of the optical element 2201 and the R1 surface of the optical element 2301 evaporated with the transmissive reflective surface (half-mirror) C. The polarization selective transmissive reflective element A is bonded to the R2 surface of the optical element 2101 included in the pupil-surface-side optical system 2100 and the R1 surface of the optical element 2201 included in the transmissive reflective optical system. In this example, the transmissive reflective surface (half-mirror) C and the first quarter waveplate B is the second transmissive reflective member, and the polarization selective transmissive reflective element A is the first transmissive reflective member.

In this example, similarly to Example 1, the two transmissive reflective surfacing are both curved surfaces. Thereby, excellent imaging performance (in other words, mage definition increase) can be achieved. In this example, similarly to Example 1, the optical elements 2101 and 2201 as refraction optical elements are cemented with each other via the first transmissive reflective member having the first transmissive reflective surface. The optical elements 2201 and 2301 as refraction optical elements are cemented with each other via the second transmissive reflective member having the second transmissive reflective surface. This configuration in which each transmissive reflective member having a transmissive reflective surface is sandwiched between refraction optical elements can improve the optical design freedom and imaging performance. Thus, this example can provides effects of securing the optical design freedom and providing high-definition images.

In this example, similarly to Example 1, the first transmissive reflective surface and the second transmissive reflective surface both have a shape that is concave on the pupil surface side, and thus both high light quantity and a wide field angle can be easily achieved.

In this example, the optical element 2101 sandwiching the first transmissive reflective surface also sandwiches the second transmissive reflective surface. With such a configuration, the optical elements 2101, 2201, and 2301 can be integrated, and thus the bending optical system can be easily manufactured and a mechanism holding the bending optical system can be simplified.

Table 3 summarizes the curvature Φ (reciprocal of the radius of curvature) for each of the R1 surface of the optical element 2101, the first transmissive reflective surface, the second transmissive reflective surface, and the R2 surface of the optical element 2301.

TABLE 3

| | RADIUS OF | |
|---|---|---|
| | CURVATURE γ | CURVATURE Φ |
| R1 SURFACE OF | ∞ | 0 |
| OPTICAL ELEMENT 2101 | | |
| FIRST TRANSMISSIVE | −23.6 | −0.04237 |
| REFLECTIVE SURFACE | | |
| SECOND TRANSMISSIVE | −24.76 | −0.04039 |
| REFLECTIVE SURFACE | | |
| R2 SURFACE OF | ∞ | 0 |
| OPTICAL ELEMENT 2301 | | |

As shown in Table 3, at least one surface of each refraction optical element adjacent to the first transmissive reflective surface or the second transmissive reflective surface has an opposite sign to that of the curvature of the first transmissive reflective surface or the second transmissive reflective surface or is close to a flat surface (with a curvature of a small absolute value), and this configuration can be easily manufactured.

In this example, ν2=57.4, ν3=22.4, and |ν2−ν3|=35 where ν2 is an Abbe number of the optical element 2201 based on the d-line, and ν3 is an Abbe number of the optical element 2301 based on the d-line. Thereby, chromatic aberration can be reduced.

In this example, the following inequality (8) may be satisfied:

$$20 \leq \vert v 2 - v 3 \vert \qquad ( 8 )$$

Inequality (8) may be replaced with inequality (8a) below:

$$25 \leq \vert v 2 - v 3 \vert \qquad ( 8 a )$$

Inequality (8) may be replaced with inequality (8b) below:

$$30 \leq \vert v 2 - v 3 \vert \qquad ( 8 b )$$

In this example, the following inequality (9) may be satisfied

$$20 \leq \vert v 1 - v 2 \vert \qquad ( 9 )$$

where ν1 is an Abbe number of the optical element 2101 based on the d-line.

Inequality (9) may be replaced with inequality (9a) below:

$$25 \leq \vert v 1 - v 2 \vert \qquad ( 9 a )$$

Inequality (9) may be replaced with inequality (9b) below:

$$30 \leq \vert v 1 - v 2 \vert \qquad ( 9 b )$$

In this example, n1=1.49171, n2=1.49171, and |n1−n2|=0 where n1 is a refractive index of the optical element 2101, and n2 is a refractive index of the optical element 2201. In this example, the following inequality (10) may be satisfied:

$$\vert n 1 - n 2 \vert \leq 0.2 \qquad ( 10 )$$

Inequality (10) may be replaced with inequality (10a) below:

$$\vert n 1 - n 2 \vert \leq 0.15 \qquad ( 10 a )$$

Inequality (10) may be replaced with inequality (10b) below:

$$\vert n 1 - n 2 \vert \leq 0.1 \qquad ( 10 b )$$

In this example, n2=1.49171, n3=1.6422, and |n2−n3|=0.15049 where n3 is a refractive index of the optical element 2301. In this example, the following inequality (11) may be satisfied:

$$\vert n 2 - n 3 \vert \leq 0.2 \qquad ( 11 )$$

Inequality (11) may be replaced with inequality (11a) below:

$$\vert n 2 - n 3 \vert \leq 0.15 \qquad ( 11 a )$$

Inequality (11) may be replaced with inequality (11b) below:

$$\vert n 2 - n 3 \vert \leq 0.1 \qquad ( 11 b )$$

Thus, the optical design freedom and imaging performance can be improved as described above by reducing the refractive index difference between refraction optical elements sandwiching each transmissive reflective surface.

In this example, similarly to Example 1, the two refraction optical elements sandwiching the first transmissive reflective surface are both made of PMMA (acrylic resin) and variation at environment change can be reduced. In this example, similarly to Example 1, the side surface of the first transmissive reflective member, which includes the polarization selective transmissive reflective element A as the first transmissive reflective surface, in the direction orthogonal to the optical axis is sealed by cementing (B in FIG. 6A) of the outer shapes of the optical elements 2101 and 2201 and does not contact air. This configuration in which the transmissive reflective surface does not directly contact air can prevent performance degradation and endurance degradation due to moisture absorption. In this example, similarly to Example 1, since the material of the optical element 2101 serving as the pupil-facing surface facing the pupil surface SP is PMMA (acrylic resin), no hard coating or antifouling glass needs to be provided and thus cost can be reduced.

Next follows a description of numerical examples 1 and 2 corresponding to Examples 1 and 2, respectively. In surface data of each numerical example, r represents a radius of curvature (mm) of the i-th surface where i represents a surface number counted from the pupil surface side. d is a lens thickness or air gap (mm) between i-th and (i+1)-th surfaces, nd is a refractive index of the material of the i-th optical member for the d-line, and νd is an Abbe number of the material of the i-th optical member based on the d-line. The Abbe number νd is expressed as follows:

$$vd = ( Nd - 1 ) / ( NF - NC )$$

where Nd, NF, and NC are refractive indices for the d-line (587.6 nm), the F line (486.1 nm), and the C line (656.3 nm) in the Fraunhofer line. An effective diameter is the maximum diameter of an area in which light from an original image passes through each surface.

In each numerical example, a focal length (mm) is a value when the optical system is in the in-focus state at infinity. The back focus is an air conversion length of a distance on the optical axis from a final lens surface that is the lens surface closest to the image plane in the zoom lens to a paraxial image plane.

An asterisk “*” provided to the surface number means that the surface has an aspherical surface shape. The aspherical surface shape is expressed with:

$$x ( h ) = \frac{( \frac{{h}^{2}}{r} )}{1 + \sqrt{\{ 1 - ( 1 + k ) {( \frac{h}{r} )}^{2} \}}} + {A}_{4} {h}^{4} + {A}_{6} {h}^{6} + {A}_{8} {h}^{8} + {A}_{10} {h}^{10} + …$$

where x is displacement in the optical axis direction at a position of a height h from the optical axis and is a reference for a surface vertex, R is a paraxial radius of curvature, k is a conic constant, and Ai (i=4, 6, 8 . . . ) is an aspherical surface coefficient of an order. In each aspherical surface coefficient, “e±XX” means “×10^{±XX}”

NUMERICAL EXAMPLE 1
UNIT: mm
SURFACE DATA

| Surface No. | r | d | nd | vd |
|---|---|---|---|---|
| 1 | ∞ | (Variable) | | |
| (Pupil Surface) | | | | |
| 2 | ∞ | 4.30 | 1.49171 | 57.4 |
| 3* | −36.600 | 0.50 | 1.52000 | 64.0 |
| 4* | −36.600 | 2.13 | 1.64220 | 22.4 |
| 5* | −60.000 | (Variable) | | |
| 6* | −165.000 | 5.17 | 1.49171 | 57.4 |
| 7* | −37.000 | 0.50 | 1.52000 | 64.0 |
| 8* | −37.000 | −0.50 | | |
| 9* | −37.000 | −5.17 | 1.49171 | 57.4 |
| 10* | −165.000 | (Variable) | | |
| 11* | −60.000 | −2.13 | 1.64220 | 22.4 |
| 12* | −36.600 | −0.50 | −1.52000 | 64.0 |
| 13* | −36.600 | 0.50 | | |
| 14* | −36.600 | 2.13 | 1.64220 | 22.4 |
| 15* | −60.000 | (Variable) | | |
| 16* | −165.000 | 5.17 | 1.49171 | 57.4 |
| 17* | −37.000 | 0.50 | 1.52000 | 64.0 |
| 18* | −37.000 | 1.00 | 1.49171 | 57.4 |
| 19 | ∞ | (Variable) | | |
| 20 | ∞ | (Variable) | | |
| Image Plane | ∞ | | | |

```
ASPHERIC DATA
  3rd Surface
K = −6.04281e+00 A 4 = 8.18061e−06
  4th Surface
K = −6.04281e+00 A 4 = 8.18061e−06
  5th Surface
K = 0.00000e+00 A 4 = 8.82583e−06
  6th Surface
K = 0.00000e+00 A 4 = −1.05670e−06
  7th Surface
K = 0.00000e+00 A 4 = 1.97220e−06
  8th Surface
K = 0.00000e+00 A 4 = 1.97220e−06
  9th Surface
K = 0.00000e+00 A 4 = 1.97220e−06
10th Surface
K = 0.00000e+00 A 4 = −1.05670e−06
11th Surface
K = 0.00000e+00 A 4 = 8.82583e−06
12th Surface
K = −6.04281e+00 A 4 = 8.18061e−06
13th Surface
K = −6.04281e+00 A 4 = 8.18061e−06
14th Surface
K = −6.04281e+00 A 4 = 8.18061e−06
15th Surface
K = 0.00000e+00 A 4 = 8.82583e−06
16th Surface
K = 0.00000e+00 A 4 = −1.05670e−06
17th Surface
K = 0.00000e+00 A 4 = 1.97220e−06
18th Surface
K = 0.00000e+00 A 4 = 1.97220e−06
```

| | |
|---|---|
| Focal Length | 29.73 |
| d1 | 12.00 |
| d5 | 1.15 |
| d10 | −1.15 |
| d15 | 1.15 |
| d19 | 0.75 |
| d20 | 0.5 |

NUMERICAL EXAMPLE 2
UNIT: mm
SURFACE DATA

| Surface No. | r | d | nd | vd |
|---|---|---|---|---|
| 1 | ∞ | 12.00 | | |
| (Pupil Surface) | | | | |
| 2 | ∞ | 5.50 | 1.49171 | 57.4 |
| 3* | −23.600 | 0.50 | 1.52000 | 64.0 |
| 4* | −23.600 | 5.50 | 1.49171 | 57.4 |
| 5* | −24.760 | 0.50 | 1.52000 | 64.0 |
| 6* | −24.760 | −0.50 | | |
| 7* | −24.760 | −5.50 | 1.49171 | 57.4 |
| 8* | −23.600 | −0.50 | 1.52000 | 64.0 |
| 9* | −23.600 | 0.50 | | |
| 10* | −23.600 | 5.50 | 1.49171 | 57.4 |
| 11* | −24.760 | 0.50 | 1.52000 | 64.0 |
| 12* | −24.760 | 1.00 | 1.64220 | 22.4 |
| 13* | ∞ | 2.496 | | |
| 14 | ∞ | 0.50 | 1.52000 | 64.0 |
| 15 | ∞ | (Variable) | | |
| Image Plane | ∞ | | | |

```
ASPHERIC DATA
  3rd Surface
K = −3.94220e+00
  4th Surface
K = −3.94220e+00
  5th Surface
K = −4.00648e−01
  6th Surface
K = −4.00648e−01
  7th Surface
K = −4.00648e−01
  8th Surface
K = −3.94220e+00
  9th Surface
K = −3.94220e+00
10th Surface
K = −3.94220e+00
11th Surface
K = −4.00648e−01
12th Surface
K = −4.00648e−01
13th Surface
K = 0.00000e+00 A 4 = 4.08491e−05 A 6 = −6.46133e−07
A 8 = 1.59847e−09
```

| | |
|---|---|
| Focal Length | 16.90 |

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

Each example can provide an optical system that can provide a high-definition image.

This application claims the benefit of Japanese Patent Application No. 2023-008475, filed on Jan. 24, 2023, which is hereby incorporated by reference herein in its entirety.

What is claimed is:

1. An optical system through which a light beam from a display surface is guided to a pupil surface, the optical system comprising, in order from a pupil surface side to a display surface side:
a first optical system having at least one lens;
a first transmissive reflective member having a first transmissive reflective surface that is a curved surface;
a second optical system having at least one lens;
a second transmissive reflective member having a second transmissive reflective surface that is a curved surface; and
a third optical system having at least one lens,
wherein a lens disposed closest to the display surface in the first optical system and a lens disposed closest to the pupil surface in the second optical system are cemented with each other via the first transmissive reflective member, and
wherein a lens disposed closest to the display surface in the second optical system and a lens disposed closest to the pupil surface in the third optical system are cemented with each other via the second transmissive reflective member.

2. The optical system according to claim 1, wherein the first optical system includes a first lens,
wherein the second optical system includes, in order from the pupil surface side to the display surface side, a second lens and a third lens,
wherein the third optical system includes a fourth lens,
wherein the first lens and the second lens are cemented with each other via the first transmissive reflective member, and
wherein the third lens and the fourth lens are cemented with each other via the second transmissive reflective member.

3. The optical system according to claim 1, wherein the first optical system includes a first lens,
wherein the second optical system includes a second lens,
wherein the third optical system includes a third lens,
wherein the first lens and the second lens are cemented with each other via the first transmissive reflective member, and
wherein the second lens and the third lens are cemented with each other via the second transmissive reflective member.

4. The optical system according to claim 1, wherein the first transmissive reflective surface and the second transmissive reflective surface each have a shape that is concave on the pupil surface side.

5. The optical system according to claim 2, wherein the second lens and the third lens are spaced from each other.

6. The optical system according to claim 5, wherein a distance between the second lens and the third lens is variable during diopter adjustment.

7. The optical system according to claim 3, wherein the second lens consists of a single lens or a cemented lens formed by cementing a plurality of lenses.

8. The optical system according to claim 1, wherein the optical system satisfies at least one of the following inequalities:
$$Φ1 a \times Φ1 b \leq 0$$
$$\vert Φ1 a \vert > \vert Φ1 b \vert$$
where Φ1a is a curvature (1/mm) of the first transmissive reflective surface, and Φ1b (1/mm) is a curvature of a lens surface of at least one of the lens disposed closest to the display surface in the first optical system and the lens disposed closest to the pupil surface in the second optical system.

9. The optical system according to claim 1, wherein the optical system satisfies at least one of the following inequalities:
$$Φ2 a \times Φ2 b \leq 0$$
$$\vert Φ2 a \vert > \vert Φ2 b \vert$$
where Φ2a is a curvature (1/mm) of the second transmissive reflective surface, and Φ2b (1/mm) is a curvature of a lens surface of at least one of the lens disposed closest to the display surface in the second optical system and the lens disposed closest to the pupil surface in the third optical system.

10. The optical system according to claim 2, wherein the optical system satisfies the following inequality:
$$7 \leq \vert v 1 b - v 2 a \vert$$
where ν1b is an Abbe number of the second lens based on d-line, and ν2a is an Abbe number of the third lens based on the d-line.

11. The optical system according to claim 2, wherein the optical system satisfies at least one of the following inequalities:
$$20 \leq \vert v 1 a - v 1 b \vert$$
$$20 \leq \vert v 2 a - v 2 b \vert$$
where ν1a is an Abbe number of the first lens based on d-line, ν1b is an Abbe number of the second lens based on the d-line, ν2a is an Abbe number of the third lens based on the d-line, and ν2b is an Abbe number of the fourth lens based on the d-line.

12. The optical system according to claim 3, wherein the optical system satisfies at least one of the following inequalities:
$$20 \leq \vert v 1 - v 2 \vert$$
$$20 \leq \vert v 2 - v 3 \vert$$
where ν1 is an Abbe number of the first lens based on d-line, ν2 is an Abbe number of the second lens based on the d-line, and ν3 is an Abbe number of the third lens based on the d-line.

13. The optical system according to claim 2, wherein the optical system satisfies the following inequality:
$$\vert n 1 a - n 1 b \vert \leq 0.2$$
where n1a is a refractive index of the first lens, and n1b is a refractive index of the second lens.

14. The optical system according to claim 2, wherein the optical system satisfies the following inequality:
$$\vert n 2 a - n 2 b \vert \leq 0.2$$
where n2a is a refractive index of the third lens, and n2b is a refractive index of the fourth lens.

15. The optical system according to claim 3, wherein the optical system satisfies at least one of the following inequalities:
$$\vert n 1 - n 2 \vert \leq 0.2$$
$$\vert n 2 - n 3 \vert \leq 0.2$$
where n1 is a refractive index of the first lens, n2 is a refractive index of the second lens, and n3 is a refractive index of the third lens.

16. The optical system according to claim 1, wherein the lens disposed closest to the display surface in the first optical system and the lens disposed closest to the pupil surface in the second optical system are made of a same material.

17. The optical system according to claim 1, wherein the lens disposed closest to the display surface in the second optical system and the lens disposed closest to the pupil surface in the third optical system are made of a same material.

18. The optical system according to claim 1, wherein at least one of the first transmissive reflective member and the second transmissive reflective member does not contact air.

19. The optical system according to claim 1, wherein an optical element disposed closest to the pupil surface in the first optical system is made of acrylic resin.

20. A display apparatus comprising:
a display element; and
the optical system according to claim 1 through which a light beam from a display surface of the display element is guided to a pupil surface.
